(19) United States
(12) Patent Application Publication
(10) Pub. No.: US 2010/0027274 A1
(43) Pub. Date: Feb. 4, 2010

(54) OPTICAL REFLECTOR

(75) Inventors: Yang LIU, Hong Kong (CN); Been Yu Liaw, Hong Kong (CN)

Correspondence Address: VENABLE LLP, P.O. BOX 34385, WASHINGTON, DC, 20043-9998, US

(73) Assignee: Hong Kong Applied Science and Technology Research Institute, Hong Kong (CN)

(21) Appl. No.: 12/181,515

(22) Filed: Jul. 29, 2008

(51) Int. Cl. F21V 7/05

(52) U.S. Cl. 362/346

(57) ABSTRACT

An optical reflector for emitting light generated from a light source, such as a light emitting diode. According to one embodiment, the optical reflector includes a plurality of panels forming a cavity, the cavity having a light receiving end and a light output end, the inner side of the cavity having a reflective surface, and wherein the cavity has a plurality of stepped layers along the inner surface of the cavity extending from the light receiving to the light output end; and wherein the light receiving end is configured to receive the light generated from the light source, and the stepped layers of the cavity are configured to reflect the light generated from the light source and emit the reflected light from the light output end in an asymmetrical distribution. Embodiments of present invention use a trapezoidal shape to create the asymmetrical output distribution.

### FIELD OF THE INVENTION

The present invention relates to lighting, and more particularly, to an optical reflector for lighting.

### BACKGROUND OF THE INVENTION

Reflectors are well known for use in directing, redirecting or focusing light generated from a light source, such as a light bulb. Reflectors are widely used, for example, in a variety of applications including indoor lighting, outdoor lighting, stage lighting, and garden lighting.

Light emitting diodes (LED) are well known and have a wide range of applications, including computing and electrical devices, decorative lights, and area lights. LED are especially useful as they are efficient, producing a large amount of light using a relatively small amount of energy.

The potential for LED lighting, especially, is currently limited, because known reflectors that are used to reflect and direct the light output from the LED are inefficient and ineffective. Accordingly, there is a need for a device that solves the shortcomings of known lighting devices.

### SUMMARY OF THE INVENTION

According to one embodiment of the present invention, an optical reflector for emitting light generated from a light source is disclosed. The optical reflector includes a plurality of panels forming a cavity, the cavity having a light receiving end and a light output end, the inner side of the cavity having a reflective surface, and wherein the cavity has a plurality of stepped layers along the inner surface of the cavity extending from the light receiving to the light output end; and wherein the light receiving end is configured to receive the light generated from the light source, and the stepped layers of the cavity are configured to reflect light generated from the light source and emit the reflected light from the light output end in an asymmetrical distribution.

According to another embodiment of the present invention, an optical reflector for emitting light generated from a light emitting diode (LED) is disclosed. The optical reflector includes a plurality of panels including a front panel, a first side panel, a second side panel, and a rear panel, the rear panel connected to the front panel by the first side panel and the second side panel, wherein the front panel, the rear panel, the first side panel, and the second side panel form a cavity, the cavity having a first opening and a second opening, each of the plurality of panels having an inner side and an outer side, the inner side of the plurality of panels forming an inner side of the cavity, the inner side of cavity having a reflective surface, and wherein the cavity has a plurality of stepped layers along the inner surface of the cavity; and wherein the first opening is configured to receive light generated from the LED, and the stepped layers of the cavity are configured to receive and reflect the light generated from the LED, and the light generated from the LED is emitted from the second opening in an asymmetrical distribution.

According to yet another embodiment of the present invention, a reflector is disclosed. The reflector includes a quadrilateral frustum shaped form having an inner surface and an outer surface, the quadrilateral frustum shaped form further defining an input opening and an output opening, the inner surface having a plurality of adjacent ridges, wherein at least a part of the inner surface is reflective.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a top view of an optical reflector, in accordance with a first embodiment of the present invention.

FIG. 2 is a bottom view of the optical reflector shown in FIG. 1, in accordance with a first embodiment of the present invention.

FIG. 3A is a cross-sectional view of the optical reflector shown in FIG. 1 taken along line A, in accordance with a first embodiment of the present invention.

FIG. 3B is a cross-sectional view of the optical reflector shown in FIG. 2 taken along line B, in accordance with a first embodiment of the present invention.

FIG. 4 is a perspective bottom view of the optical reflector shown in FIG. 1, in accordance with a first embodiment of the present invention.

FIG. 5 is a side view of the optical reflector shown in FIG. 1, in accordance with a first embodiment of the present invention.

FIG. 6 is a rear view of the optical reflector shown in FIG. 1, in accordance with a first embodiment of the present invention.

FIG. 7 is a front view of the optical reflector shown in FIG. 1, in accordance with a first embodiment of the present invention.

FIG. 8 is an illuminance map of the output of the optical reflector shown in FIG. 1, in accordance with a first embodiment of the present invention.

FIG. 9 is a top view of an optical reflector, in accordance with a second embodiment of the present invention.

FIG. 10 is a bottom view of the optical reflector shown in FIG. 1, in accordance with a second embodiment of the present invention.

FIG. 11 is a perspective bottom view of the optical reflector shown in FIG. 1, in accordance with a second embodiment of the present invention.

FIG. 12 is a side view of the optical reflector shown in FIG. 1, in accordance with a second embodiment of the present invention.

FIG. 13 is a rear view of the optical reflector shown in FIG. 1, in accordance with a second embodiment of the present invention.

FIG. 14 is a front view of the optical reflector shown in FIG. 1, in accordance with a second embodiment of the present invention.

FIG. 15 is an illuminance map of the output of the optical reflector shown in FIG. 1, in accordance with a second embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive. Like elements in each of the figures are referred to by like reference numbering.

Generally, the present invention is directed to an optical reflector for emitting light generated by a light source. According to one embodiment, the optical reflector may have a generally trapezoidal shape, having a cavity with a light receiving end and a light output end. The internal sides of the cavity may be reflective with a plurality of stepped layers, or channels, for reflecting the light out of the light output end.

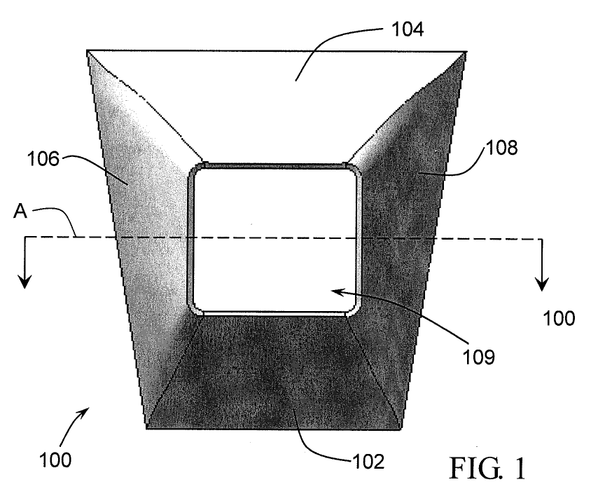

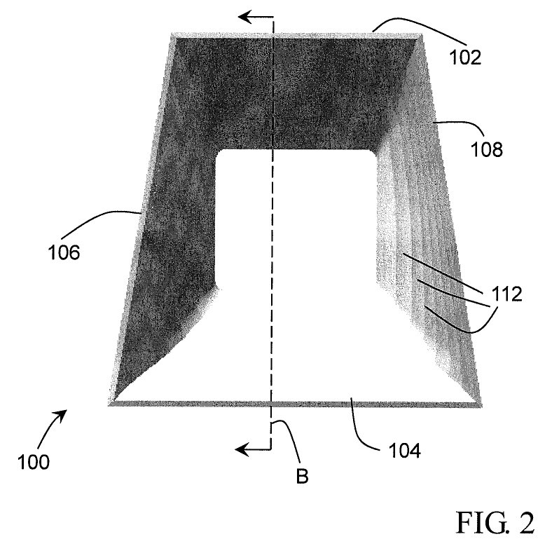

Referring now to FIGS. 1 and 2, FIG. 1 is a top view of an optical reflector 100, and FIG. 2 is a bottom view of the optical reflector 100, in accordance with a first embodiment of the present invention. The optical reflector 100 has a front panel 102, a rear panel 104, a first side panel 106, and a second side panel 108. Together the front panel 102, the rear panel 104, the first side panel 106 and the second side panel 108 may be referred to as “the panels.” Each of the panels may angle outward from the top to the bottom of the optical reflector 100, forming a four-sided cavity inside of the optical reflector 100, the cavity flaring from top to bottom. The inner surface of each panel is generally reflective, thereby forming a reflective cavity within the optical reflector. According to one embodiment, only part of the inner surface of each panel is reflective, or at least a part of the inner surface of the cavity is reflective. The lateral alignment of the front panel 102 is generally parallel to the lateral alignment of the rear panel 104. A first angle formed by the first side panel 106 and the front panel 102 and a second angle formed by the second side panel 108 and the front panel 102 are generally equal. Similarly, a third angle formed by the first side panel 106 and the rear panel 104 and a fourth angle formed by the second side panel 108 and the rear panel 104 are also generally equal. Therefore, the optical reflector has the shape of a truncated trapezoidal shaped pyramid.

Illustrated embodiments of the optical reflector have the general shape of a quadrilateral frustum, or an apex-truncated quadrilateral pyramid. A lateral cross section of the optical reflector thereby has a quadrilateral or, according to the embodiment, a trapezoidal shape.

The panels of the optical reflector 100 form a generally square or quadrilateral opening 109 at the top end of the optical reflector 100 and a larger, isosceles trapezoid shaped opening 110 (FIG. 2) at the bottom end of the optical reflector. In use, the top end of the optical reflector 100 is positioned over a light source, and the light is emitted from, or reflected out of, the trapezoidal opening 110 of the optical reflector 100.

One example application for embodiments of the optical reflector is LED lighting, as the configuration of the optical reflector may be specifically adapted for LED light. However, the optical reflector is not limited to LED lighting applications and may be used with other types of lighting, such as incandescent, fluorescent, high intensity discharge, low pressure sodium, solar or any other lighting types. Embodiments of the optical reflector may be used for any lighting application, such as lamps, street lamps, garden lighting, mobile lighting, indoor lighting, outdoor lighting, building lighting, decorative lighting, safety lighting, and other suitable applications.

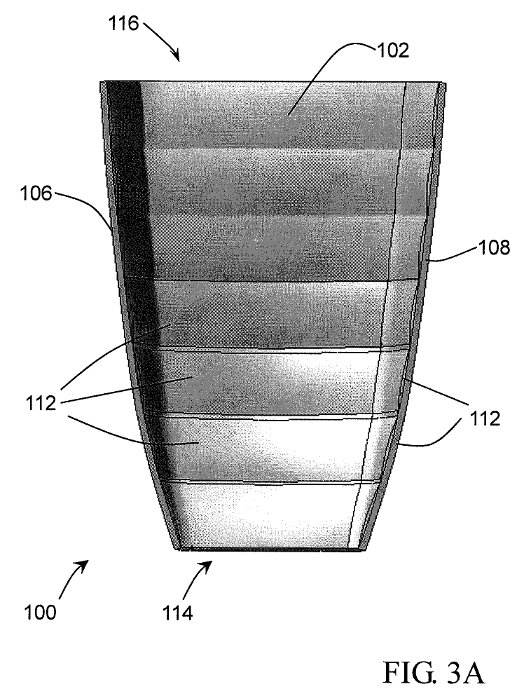

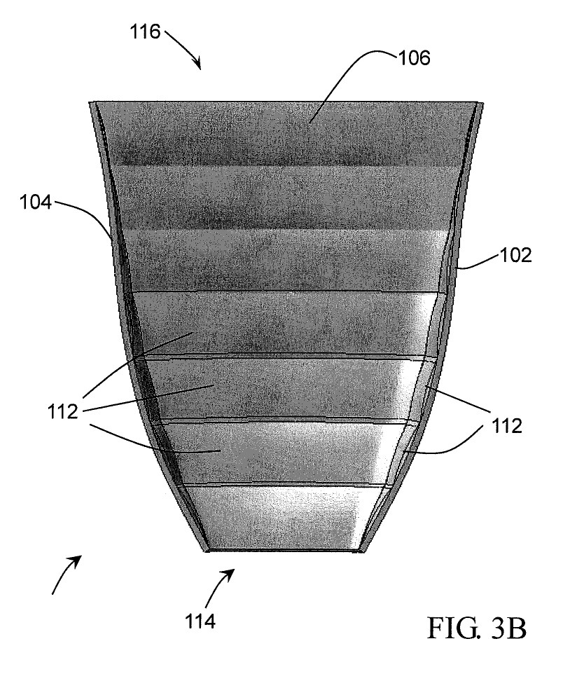

Referring specifically to FIG. 2, the inner side of the panels has stepped, circumferential layers 112 along the inner surface of the panels. The stepped layers include a plurality of adjacent ridges extending from the top end to the bottom end of each of the panels of the optical reflector 100. The stepped layers 112 create a generally ribbed or gradated appearance, each of the stepped layers 112 forming a four-edge ring shaped ridge around the inner side of the optical reflector 100 panels. Accordingly, the terms “ridge” and “stepped layer” may be used interchangeably. The shape of the stepped layers 112 are more easily seen and described with reference to FIGS. 3A and 3B. According to one embodiment, the internal surface of the optical reflector 100 has a matte finish that can serve to increase the uniformity of the light output. However, other finishes may be used on the internal surface as required by the particular application. According to one embodiment, the reflective surfaces include vacuum deposited aluminum. According to another embodiment, the reflective surfaces include vacuum deposited silver. According to another embodiment, the reflective surface may include aluminum, silver, or a combination of aluminum and silver applied according to any suitable method.

FIG. 3A is a cross-sectional view of the optical reflector shown in FIG. 1 taken along line A, in accordance with a first embodiment of the present invention. A cross section of the first side panel 106 and the second side panel 108 can be seen in FIG. 3A. The shape of each of the stepped layers 112 seen at the first side panel 106 and the second side panel 108 can be more easily seen in the cross-sectional view illustrated in FIG. 3A. In the illustrated embodiment, each of the stepped layers 112 has a convex arc, curving away from the panel. The shape, height, and depth of the curvature of different stepped layers may vary. The optical reflector 100 has a top end 114 and a bottom end 116.

FIG. 3B is a cross-sectional view of the optical reflector shown in FIG. 2 taken along line B. A cross section of the front panel 102 and the rear panel 104 can be seen in FIG. 3B. The shape of each of the stepped layers 112 of the front panel 102 and the rear panel can be seen in the cross-sectional view illustrated in FIG. 3B.

While each of the stepped layers 112 has generally the same height, the height of the stepped layers may be varied to achieve the desired light output. Additional, the value of the arc radius and shape of the arc may vary in different layers, varying from approximately two (2) millimeters to approximately forty (40) millimeters. In one embodiment, the arc radius varies with a range of approximately three (3) millimeters to approximately twelve (12) millimeters. While example ranges are given, the amount of variation may depend on what output uniformity is desired, the size of the reflector, and the intensity of the light source. It will be appreciated that the arc values may also vary depending on the shape of the optical reflector being used and the specific application for the lighting. Additionally, while a certain arc radius is illustrated in the figures, other suitable arc radii may be used.

The choice of an arc radius value includes a trade-off between optical loss and uniformity value. The smaller the radius value, the better the uniformity, and in turn, the greater the optical loss from the optical reflector, since the optical loss is at least partially caused by the reflection and diffraction of light in the optical reflector as the light emitted from the light source interacts with each of the stepped layers. However, the amount of optical loss due to this reflection and diffraction is small, and therefore acceptable, as the increase in the uniformity of the output light is substantial.

In one embodiment, the amount of optical loss is approximately 3% or less than 3% of the total optical power.

According to one embodiment of the present invention, the arc radius may be within a range of approximately eight (8) millimeters to approximately fifteen (15) millimeters, the arc radius varying from the bottom layer to the top layer. Other shapes can also be used in stepped inner layer, such as other curved shapes or a combination of curves and straight lines and angles.

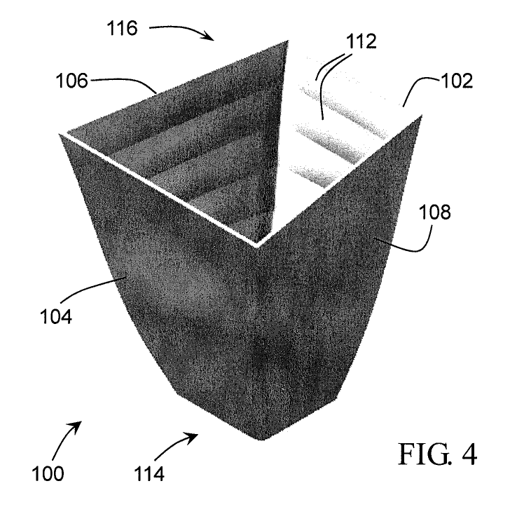

FIG. 4 is a perspective bottom view of the optical reflector shown in FIG. 1, in accordance with a first embodiment of the present invention. The optical reflector includes the front panel 102, the rear panel 104, the first side panel 106, and the second side panel 108. The stepped inner layers 112 can also be seen in the perspective view.

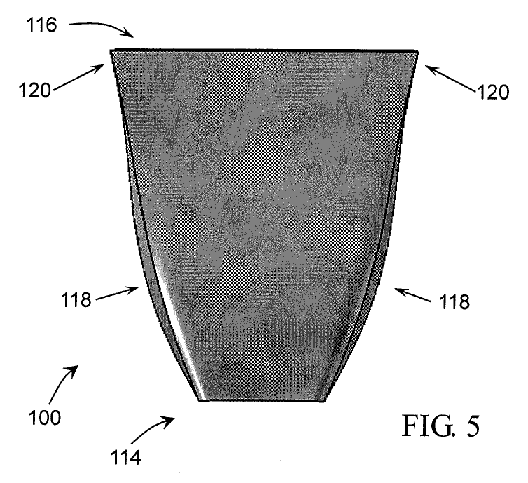

FIG. 5 is a side view of the optical reflector shown in FIG. 1, in accordance with a first embodiment of the present invention. The side view of the first side panel 106 and the side view of the second side panel 108 are generally the same, therefore only one side view is shown. As seen in the side view, the front panel 102 and rear panel 104 of the optical reflector 100 have some curvature, indicated by reference number 118. Additionally, at the bottom end 116 of the optical reflector 100, the front panel 102 and the rear panel 104 may include a flare, indicated by reference number 120.

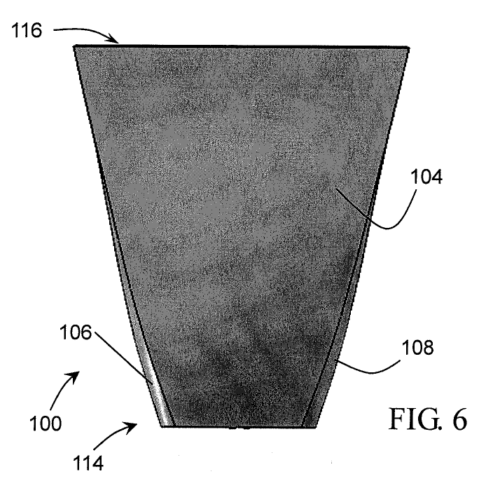

FIG. 6 is a rear side view of the optical reflector shown in FIG. 1, in accordance with a first embodiment of the present invention. The rear panel 104 may generally have the shape of an isosceles trapezoid. Slight curvature on the first side panel 106 and the second side panel 108 can be seen near the top end 114 of the optical reflector.

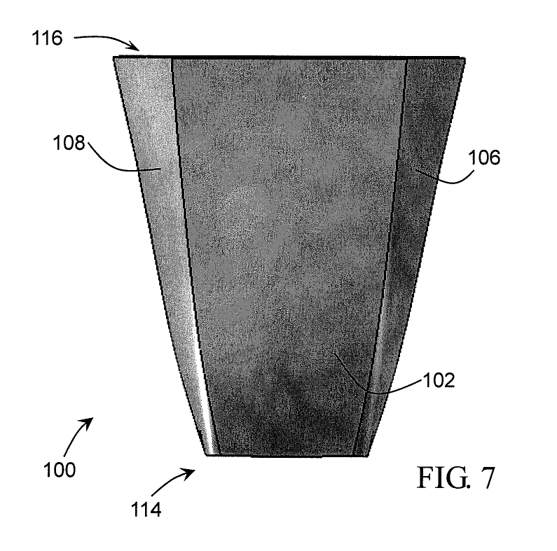

FIG. 7 is a front view of the optical reflector shown in FIG. 1, in accordance with a first embodiment of the present invention. The front panel 102 may also generally have the shape of an isosceles trapezoid, the width of the trapezoid being narrower than the rear panel 104 (FIG. 6). However, the shapes and relative sizes of each of the panels is not intended to be limited to the illustrated embodiments. The first side panel 106 and the second side panel 108 can be seen flaring out toward the rear panel 104 of the optical reflector 100.

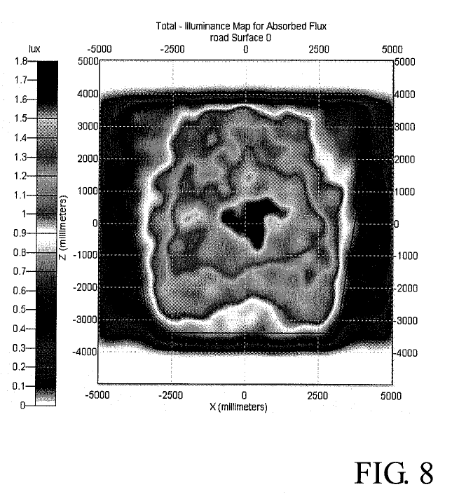

FIG. 8 is an illuminance map of the output of the optical reflector shown in FIG. 1, in accordance with a first embodiment of the present invention. The illuminance map is the result of computer assisted optical analysis showing the output extending up to approximately a five (5) meter radius at a distance of approximately ten (10) meters from the light source. The illuminance map shows that the optical reflector produces an asymmetrical output distribution. This kind of asymmetrical output distribution is well suited for certain applications including, but not limited to, outdoor lighting and decorative building lighting. However, asymmetrical light output may also be used for any other desired applications.

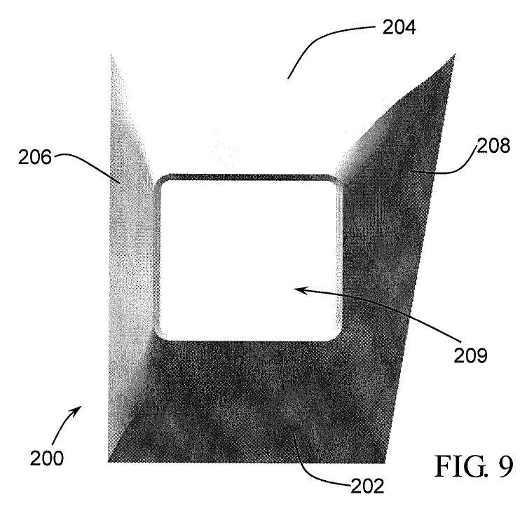

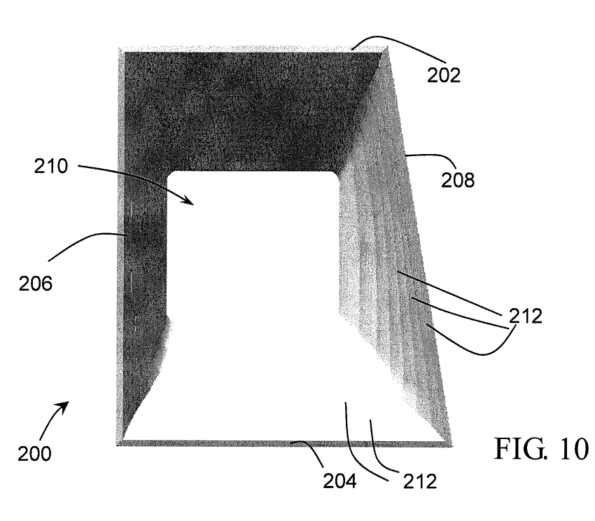

Referring now to FIGS. 9 to 15, FIG. 9 is a top view of an optical reflector 200, and FIG. 10 is a bottom view of the optical reflector 200, in accordance with a second embodiment of the present invention. Unless specifically stated otherwise, the above description relating to the first embodiment of the present invention illustrated in FIGS. 1 to 8 similarly applies to the second embodiment illustrated in FIGS. 9 to 15.

The optical reflector 200 has a front panel 202, a rear panel 204, a first side panel 206, and a second side panel 208. Together the front panel 202, the rear panel 204, the first side panel 206, and the second side panel 208 may be referred to as “the panels.” Each of the panels may angle outward from the top to the bottom of the optical reflector 200, forming a four-sided cavity inside of the optical reflector 200. The lateral alignment of the front panel 202 is generally parallel to the lateral alignment of the rear panel 204. A first angle formed by the first side panel 206 and the front panel 202 and a second angle formed by the second side panel 208 and the front panel 202 are not equal. Similarly, a third angle formed by the first side panel 206 and the rear panel 204 and a fourth angle formed by the second side panel 208 and the rear panel 204 are also generally not equal. This inequality in these angles provides, generally, some irregularity in the trapezoidal shape of the optical reflector 200.

The panels of the optical reflector 200 form a generally square or quadrilateral opening 209 at the top end of the optical reflector 200 and a larger, trapezoid shaped opening 210 (FIG. 2) at the bottom end of the optical reflector. In use, the top end of the optical reflector 200 is positioned over a light source, such as one or more LED, and the light is emitted from, reflected out of, the trapezoidal opening 210 of the optical reflector.

Referring to the second embodiment of the optical reflector, it should be noted that the bottom end opening 210 of the optical reflector is trapezoid shaped, in contrast to the isosceles trapezoid shaped opening 110 (FIG. 2) illustrated in the first embodiment. Specifically, the trapezoid shaped, bottom end opening 210 is a right angled trapezoid. However, these two shapes of the bottom end opening illustrated in the first and second embodiments, isosceles trapezoid and right angled trapezoid, respectively, are only examples of suitable shapes for use with embodiments of the present invention. The shape of the bottom end opening may also include other quadrilateral shapes, including but not limited to simple, convex, concave, tangential, cyclic, trapezoid, kite, parallelogram, rhombus, bicentric, rectangular, square, or other quadrilateral shapes. The shape of the top end opening may similarly have any other suitable shape. While quadrilateral shapes are considered and illustrated, embodiments of the present invention should not be limited to quadrilateral shapes, and optical reflectors according to embodiments of the present invention may have three or more sides. Also, as illustrated, the panels are generally flat with some curvature. However, the topography of each of the panels may take any suitable form.

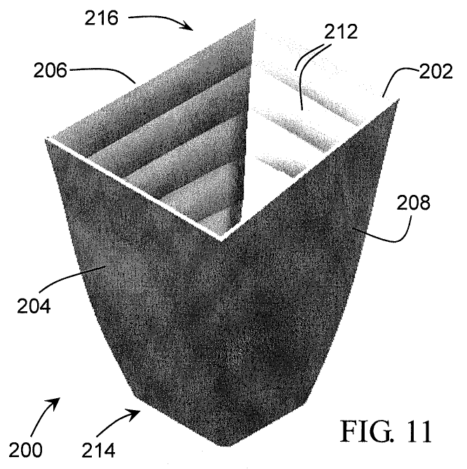

Referring specifically to FIG. 10, the inner side of the panels has a plurality of stepped, circumferential layers 212 along the inner surface of the panels. The stepped layers 212 create a generally ribbed or gradated appearance, each of the stepped layers forming a four-edged ring-shaped ridge around the inner side of the optical reflector. The stepped layers 212 are also seen in FIG. 11. The description of the stepped layers with reference to FIGS. 2 to 4 similarly applies to the stepped layers of the second embodiment shown and described with reference to FIGS. 9 to 15.

FIG. 11 is a perspective bottom view of the optical reflector shown in FIG. 9, in accordance with a second embodiment of the present invention. The optical reflector includes the front panel 202, the rear panel 204, the first side panel 206, and the second side panel 208. The stepped inner layers 212 can also be seen in the perspective view. The optical reflector 200 has a top end 214 and a bottom end 216.

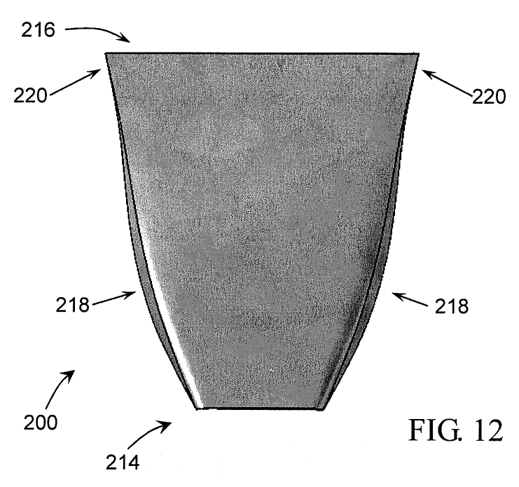

FIG. 12 is a side view of the optical reflector shown in FIG. 1, in accordance with a second embodiment of the present invention. The side view of the first side panel 206 and the side view of the second side panel 208 are generally the same, therefore only one side view is shown. As seen in the side view, the front panel 202 and rear panel 204 of the optical reflector 100 have some curvature, indicated by reference number 218. Additionally, at the bottom end 216 of the optical reflector 200, the front panel 202 and the rear panel 204 may include a flare, indicated by reference number 220.

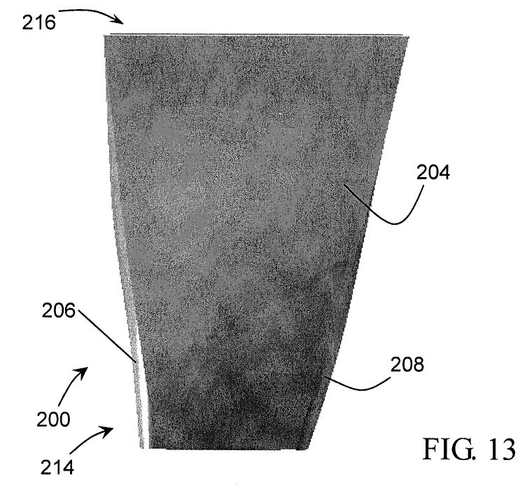

FIG. 13 is a rear view of the optical reflector shown in FIG. 9, in accordance with a second embodiment of the present invention. The rear panel 204 may have a generally trapezoid shape. Slight curvature may be seen on the first side panel 206 and the second side panel 208 near the top end 214 of the optical reflector 200.

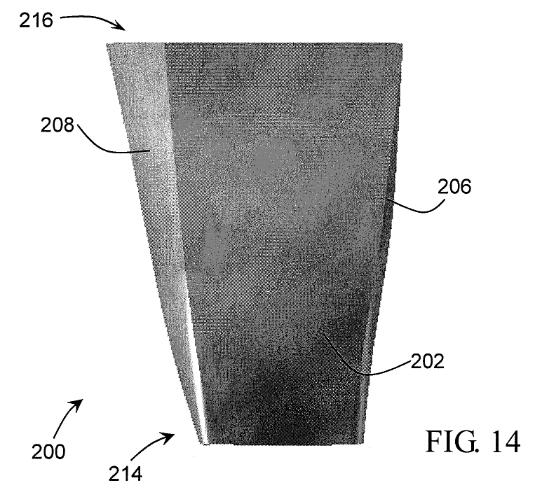

FIG. 14 is a front view of the optical reflector shown in FIG. 9, in accordance with a second embodiment of the present invention. The front panel 202 may also have a generally trapezoid shape, the width of the trapezoid being narrower than the rear panel 204 (FIG. 13). Some curvature may also be seen in this view on the first side panel 206 and the second side panel 208 near the top end 214 of the optical reflector 200.

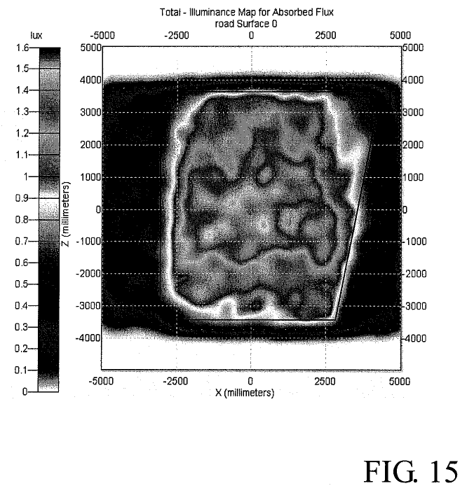

FIG. 15 is an illuminance map of the output of the optical reflector shown in FIG. 9, in accordance with a second embodiment of the present invention. The illuminance map is the result of computer assisted optical analysis showing the output extending up to approximately a five (5) meter radius at a distance of approximately ten (10) meters from the light source. The illuminance map shows that the optical reflector has an asymmetrical output distribution.

One advantage of optical reflectors configured according to embodiments of the present invention is the generation of an asymmetrical optical distribution. The terminology “asymmetrical optical distribution” is used to describe the optical output as being not symmetric about a single plane or a single line.

In one example application of the optical reflector, when used in an LED street lamp, the optical distribution on the road has greater uniformity, especially when compared with a conventional street lamp having a symmetrical optical distribution.

While the invention has been particularly shown and described with reference to the illustrated embodiments, those skilled in the art will understand that changes in form and detail may be made without departing from the spirit and scope of the invention. For example, the shape and size of the optical reflector, and its panels relative to each other, may be varied. Also, the amount of curvature shown in the respective panels may also be varied. The outward flare shape of embodiments may also flare at different angles or degrees.

Embodiments of the optical reflector may be made out of any suitable material, including, but not limited to, glass based materials, metal and metal based materials, plastic and polymer based materials, natural materials, reconstituted materials, and/or any suitable combination of two or more different materials.

Accordingly, the above description is intended to provide example embodiments of the present invention, and the scope of the present invention is not to be limited by the specific examples provided.

What is claimed is:

1. An optical reflector for emitting light generated from a light source, the optical reflector comprising:
a plurality of panels forming a cavity, the cavity having a light receiving end and a light output end, the inner side of the cavity having a reflective surface, and wherein the cavity has a plurality of stepped layers along the inner surface of the cavity extending from the light receiving to the light output end; and wherein the light receiving end is configured to receive the light generated from the light source, and the stepped layers of the cavity are configured to reflect light generated from the light source and emit the reflected light from the light output end in an asymmetrical distribution.

2. The optical reflector of claim 1, wherein the plurality of panels includes four panels and the optical reflector has a trapezoidal shape.

3. The optical reflector of claim 2, wherein the light output end of the cavity has an isosceles trapezoidal shape.

4. The optical reflector of claim 2, wherein the light output end of the cavity has a right angled trapezoidal shape.

5. The optical reflector of claim 1, wherein each of the plurality of stepped layers has a convex arc.

6. The optical reflector of claim 5, wherein the convex arc has an arc radius within a range from approximately three (3) millimeters to approximately twelve (12) millimeters.

7. The optical reflector of claim 1, wherein the reflective surface includes vacuum deposited aluminum.

8. The optical reflector of claim 1, wherein the reflective surface includes vacuum deposited silver.

9. An optical reflector for emitting light generated from a light emitting diode (LED), the optical reflector comprising:
a plurality of panels including a front panel, a first side panel, a second side panel, and a rear panel, the rear panel connected to the front panel by the first side panel and the second side panel, wherein the front panel, the rear panel, the first side panel, and the second side panel form a cavity, the cavity having a first opening and a second opening, each of the plurality of panels having an inner side and an outer side, the inner side of the plurality of panels forming an inner side of the cavity, the inner side of cavity having a reflective surface, and wherein the cavity has a plurality of stepped layers along the inner surface of the cavity; and wherein the first opening is configured to receive light generated from the LED, and the stepped layers of the cavity are configured to receive and reflect the light generated from the LED, and the light generated from the LED is emitted from the second opening in an asymmetrical distribution.

10. The optical reflector of claim 9, wherein the second opening the cavity has a trapezoidal shape.

11. The optical reflector of claim 10, wherein the second opening the cavity has an isosceles trapezoidal shape.

12. The optical reflector of claim 10, wherein the second opening the cavity has a right angled trapezoidal shape.

13. The optical reflector of claim 9, wherein the optical reflector has a trapezoidal frustum shape.

14. The optical reflector of claim 9, wherein each of the plurality of stepped layers has a convex arc.

15. The optical reflector of claim 14, wherein the convex arc has an arc radius within a range from approximately three (3) millimeters to approximately twelve (12) millimeters.

16. The optical reflector of claim 9, wherein the reflective surface includes vacuum deposited aluminum.

17. The optical reflector of claim 9, wherein the reflective surface includes vacuum deposited silver.

18. A reflector comprising:
a quadrilateral frustum shaped form having an inner surface and an outer surface, the quadrilateral frustum shaped form further defining an input opening and an output opening, the inner surface having a plurality of adjacent ridges, wherein at least a part of the inner surface is reflective.

19. The reflector of claim 18, wherein the quadrilateral frustum shaped reflector is trapezoidal frustum shaped.

20. The reflector of claim 18, wherein the quadrilateral frustum shaped form is configured to output light from the output opening in an asymmetrical distribution.
